(19) United States
(12) Patent Application Publication
(10) Pub. No.: US 2017/0058823 A1
(43) Pub. Date: Mar. 2, 2017

(54) CYLINDER HEAD WITH BLENDED INLET VALVE SEAT FOR HIGH TUMBLE INLET PORT

(71) Applicant: GM GLOBAL TECHNOLOGY OPERATIONS LLC, Detroit, MI (US)

(72) Inventors: Alan W. Hayman, Romeo, MI (US); Kenneth M. Eastman, Troy, MI (US); Edward J. Keating, Ortonville, MI (US); Erwan Gautier, Plymouth, MI (US)

(73) Assignee: GM GLOBAL TECHNOLOGY OPERATIONS LLC, Detroit, MI (US)

(21) Appl. No.: 14/833,812

(22) Filed: Aug. 24, 2015

(51) Int. Cl. F02F 1/42

(52) U.S. Cl. CPC F02F 1/4285

(57) ABSTRACT

A cylinder head defines an inlet port having an exit. A valve seat insert defines a seat cut surface that is disposed adjacent to the exit of the inlet port. A cross section of the inlet port parallel to a centerline of the inlet port defines a long turn edge of the inlet port cross section. The long turn edge of the inlet port cross section defines a flow path trajectory of the inlet port. The seat cut surface and the flow path trajectory are substantially aligned to extend the flow path trajectory of the long turn edge of the inlet port cross section across the seat cut surface.

### TECHNICAL FIELD

The disclosure generally relates to a cylinder head for an internal combustion engine.

### BACKGROUND

Internal combustion engines include a cylinder head, which covers one or more cylinder bores of an engine block. The cylinder head defines an inlet port, through which a mixture of fuel and air is introduced into the cylinder bore. The cylinder head moveably supports an inlet valve, which operates to open and close the inlet port during the operating cycle of the engine. A sharp change in direction of the inlet port, particularly at the inlet valve seat and exit of the inlet port into the cylinder bore, may disrupt or introduce turbulence into the flow of the fuel/air mixture.

### SUMMARY

A cylinder head for an internal combustion engine is provided. The cylinder head includes a structure, which defines an inlet port. The inlet port includes an exit. A seat cut surface is disposed adjacent the exit of the inlet port. The inlet port extends along a centerline. A cross section of the inlet port parallel to the centerline defines a long turn edge of the inlet port cross section, and an opposing sharp turn edge of the inlet port cross section. The long turn edge of the inlet port cross section defines a flow path trajectory that is substantially tangent with the long turn edge of the inlet port cross section at the exit of the inlet port. The flow path trajectory projects to an intersection with a bore axis that forms an acute, interior angle that is greater than 30°. The seat cut surface and the flow path trajectory are substantially aligned to extend the flow path trajectory of the long turn edge of the inlet port cross section across the seat cut surface.

An internal combustion engine is also provided. The internal combustion engine includes a block that defines at least one cylinder bore extending along a bore axis. A cylinder head is attached to the block. The cylinder head includes an inlet port having an exit. The inlet port is operable to introduce a mixture of fuel and air into the cylinder bore. The cylinder head includes a throat cut surface at the exit of the inlet port. An inlet valve is moveably supported by the cylinder head. The inlet valve includes a seat. A valve seat insert is coupled to the structure. The valve seat insert is disposed around a periphery of the exit of the inlet port. The valve seat insert defines a seat cut surface disposed adjacent the throat cut surface at the exit of the inlet port. The seat cut surface and the seat of the inlet valve are shaped to engage each other in sealing engagement for sealing the exit of the inlet port. The inlet port extends along a centerline. A cross section of the inlet port along a plane defined by the centerline of the inlet port and the bore axis defines a long turn edge of the inlet port cross section, and an opposing sharp turn edge of the inlet port cross section. The long turn edge of the inlet port cross section defines a flow path trajectory that is substantially tangent with the long turn edge of the inlet port cross section at the exit of the inlet port. The flow path trajectory projects to an intersection with the bore axis that forms an acute, interior angle that is greater than 30°. The seat cut surface and the throat cut surface are substantially aligned with the flow path trajectory to extend the flow path trajectory of the long turn edge of the inlet port cross section across both the throat cut surface and the seat cut surface.

Accordingly, because the seat cut surface and the throat cut surface are generally aligned with the flow path trajectory defined by the inlet port, the flow of the fuel/air mixture is not disrupted as the fuel/air mixture passes across the seat cut surface and into the cylinder bore, thereby reducing turbulence in the flow of the fuel/air mixture and improving performance of the internal combustion engine. The seat cut surface is generally aligned with the throat cut surface to substantially extend the flow path trajectory of the inlet port without interference and/or disruption.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic fragmentary partially cross sectioned view of an internal combustion engine.

FIG. 2 is a schematic, enlarged fragmentary partially cross sectioned view of the internal combustion engine

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, an internal combustion engine is generally shown at 20. The internal combustion engine 20 may include any style and/or configuration of engine. For example, the internal combustion engine 20 may include, but is not limited to, a gasoline engine or a diesel engine. Additionally, the internal combustion engine 20 may be configured as, but is not limited to, an inline motor or a V-style motor.

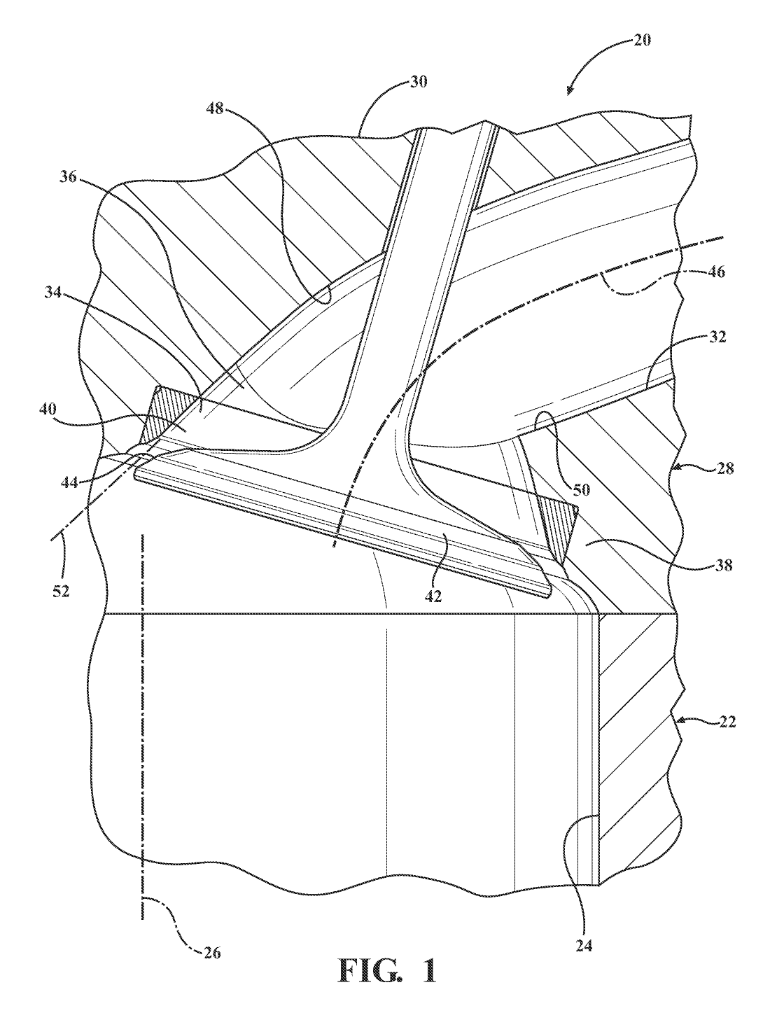

Referring to FIG. 1, the internal combustion engine 20 includes a block 22. The block 22 defines at least one cylinder bore 24. The cylinder bore 24 extends along a bore axis 26. A piston (not shown) moves in a reciprocating motion within the cylinder bore 24 as is known in the art. A cylinder head 28 is attached to the block 22. The cylinder head 28 forms the end of the cylinder bore 24, against which the piston compresses a combustion charge during the operating cycle of the engine.

The cylinder head 28 includes a structure 30. The structure 30 defines at least one inlet port 32 and at least one exhaust port (not shown) per cylinder bore 24. The inlet port 32 includes an exit 34 disposed adjacent the cylinder bore 24. The inlet port 32 is operable to introduce or direct a mixture of fuel and air, forming the combustion charge, into the cylinder bore 24. The cylinder head 28 includes a throat cut surface 36 disposed at the exit 34 of the inlet port 32. The throat cut surface 36 is defined by the structure 30, and partially defines the inlet port 32, adjacent the exit 34 of the inlet port 32.

A valve seat insert 38 is coupled to the structure 30. The valve seat insert 38 is disposed around a periphery or circumference of the exit 34 of the inlet port 32. The valve seat insert 38 may be coupled to the structure 30 in any suitable manner, such as but not limited to a press fit connection. The intersection or joint between the inlet port 32 and the valve seat 44 defines the exit 34 of the inlet port 32. The valve seat insert 38 is formed to define a seat cut surface 40. The seat cut surface 40 is disposed adjacent the throat cut surface 36, at the exit 34 of the inlet port 32. Accordingly, the seat cut surface 40 is disposed adjacent the exit 34 of the inlet port 32, downstream of the throat cut surface 36 of the inlet port 32.

The internal combustion engine 20 includes at least one inlet valve 42 for each inlet port 32. The inlet valve 42 is moveably supported by the cylinder head 28. The inlet valve 42 includes and/or defines a seat 44. The seat cut surface 40 and the seat 44 of the inlet valve 42 are shaped to engage each other in sealing engagement for sealing the exit 34 of the inlet port 32. As is known, the inlet valve 42 moves in a reciprocating motion to open and close fluid communication between the inlet port 32 and the cylinder bore 24, during the operation of the engine cycle.

The inlet port 32 extends along a centerline 46, between an entrance (not shown) and the exit 34. It should be appreciated that the centerline 46 of the inlet port 32 may be a curvilinear, and is generally defined as the three dimensional center of the inlet port 32, extending between the entrance and the exit 34. A cross section of the inlet port 32, shown in FIG. 1, parallel to the centerline 46 and parallel to the bore axis 26, defines a long turn edge 48 of the inlet port 32 cross section, and an opposing sharp turn edge 50 of the inlet port 32 cross section. The cross section of the inlet port 32 may be defined as the cross section of the inlet port 32 taken along a plane that is defined by the centerline 46 of the inlet port 32 and the bore axis 26.

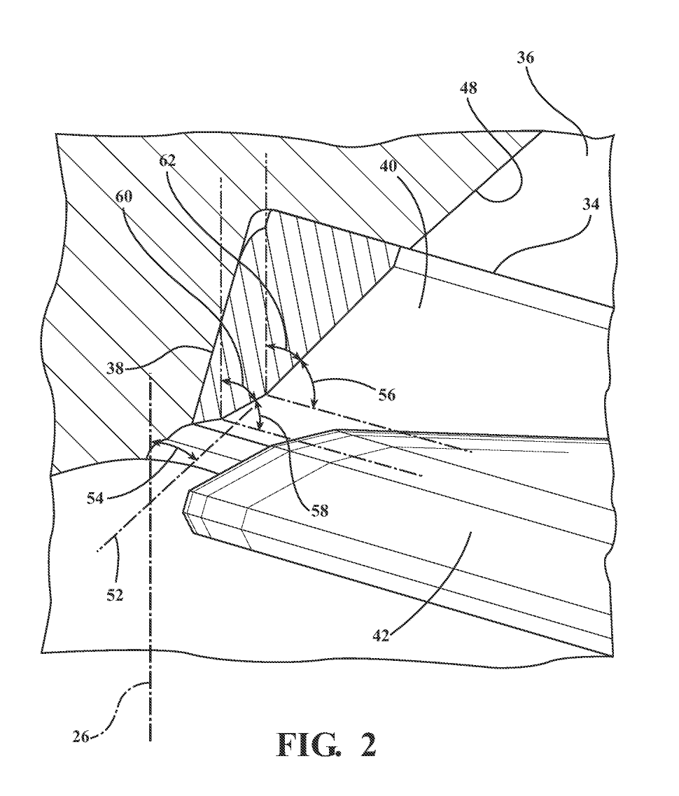

The long turn edge 48 of the inlet port 32 cross section defines a flow path trajectory 52. The flow path trajectory 52 is the flow path that the air/fuel mixture follows along the long turn edge 48 of the inlet port 32 cross section as the air/fuel mixture flows through the inlet port 32 and nears the exit 34 of the inlet port 32. The flow path trajectory 52 is substantially tangent with the long turn edge 48 of the inlet port 32 cross section at the exit 34 of the inlet port 32. Referring to FIG. 2, the flow path trajectory 52 projects outward from the inlet port 32, into the cylinder bore 24, to an intersection with the bore axis 26, to form an acute, interior angle 54 with the bore axis 26 that is greater than 30°. Due to the angle 54 of the flow path trajectory 52 of the inlet port 32 relative to the bore axis 26, the inlet port 32 may be defined as a “High Tumble Port” by those skilled in the art.

The throat cut surface 36 and the seat cut surface 40 are substantially aligned with each other around the perimeter or circumference of the exit 34 of the inlet port 32. By shaping the seat cut surface 40 and the throat cut surface 36 to align with each other, the throat cut surface 36 is substantially an extension of the seat cut surface 40 into the inlet port 32. Stated in reverse, the seat cut surface 40 is substantially an extension of the throat cut surface 36 from the inlet port 32, and into the cylinder bore 24.

Referring to FIG. 2, the throat cut surface 36 and the seat cut surface 40 each define a respective inward taper angle relative to a reference plane. The reference plane may be defined by a plane on which the exit 34 of the inlet port 32 lies. As described herein, the throat cut surface 36 and the seat cut surface 40 are substantially aligned with each other when an inward taper angle 56 of the throat cut surface 36 and an inward taper angle 58 of the seat cut surface 40 are within 10° of each other, relative to the reference plane. More preferably, the inward taper angle 56 of the throat cut surface 36 and the inward taper angle 58 of the seat cut surface 40 are within 5° of each other, relative to the reference plane. For example, if the inward taper angle 56 of the throat cut surface 36 relative to the reference plane is equal to 45°, then the throat cut surface 36 and the seat cut surface 40 are substantially aligned with each other when the inward taper angle 58 of the seat cut surface 40 relative to the reference plane is between 35° and 55°.

The seat cut surface 40 and the throat cut surface 36 are also substantially aligned with the flow path trajectory 52. The seat cut surface 40 is aligned with the flow path trajectory 52 to extend the flow path trajectory 52 of the long turn edge 48 of the inlet port 32 cross section across both the throat cut surface 36 and the seat cut surface 40, so that the inlet port 32 does not disrupt or introduce turbulence into the flow of the fuel/air mixture as the fuel/air mixture is introduced into the cylinder bore 24.

As described herein, the seat cut surface 40 and the flow path trajectory 52 are substantially aligned with each other when an angular difference between the flow path trajectory 52 and the seat cut surface 40 relative to the bore axis 26 is between 0° and 10°, and more preferably, between 0° and 5°. Similarly, as described herein, the throat cut surface 36 and the flow path trajectory 52 are substantially aligned with each other when an angular difference between the flow path trajectory 52 and the throat cut surface 36 relative to the bore axis 26 is between 0° and 10°, and more preferably, between 0° and 5°.

For example, with reference to FIG. 2, if the projection of the flow path trajectory 52 intersects the bore axis 26, and forms the interior angle 54 therebetween that is equal to 60°, then the seat cut surface 40 may be considered substantially aligned with the flow path trajectory 52 when a linear projection from the seat cut surface 40 to an intersection with the bore axis 26 forms an interior angle 60 that is between 50° and 70°. Similarly, the throat cut surface 36 may be considered substantially aligned with the flow path trajectory 52 when a linear projection from the throat cut surface 36 to an intersection with the bore axis 26 forms an interior angle 62 that is between 50° and 70°.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A cylinder head for an internal combustion engine, the cylinder head comprising:
a structure defining an inlet port having an exit;
a seat cut surface disposed adjacent the exit of the inlet port;
wherein the inlet port extends along a centerline, and wherein a cross section of the inlet port parallel to the centerline defines a long turn edge of the inlet port cross section and an opposing sharp turn edge of the inlet port cross section;
wherein the long turn edge of the inlet port cross section defines a flow path trajectory that is substantially tangent with the long turn edge of the inlet port cross section at the exit of the inlet port, and projects to an intersection with a bore axis that forms an acute, interior angle that is greater than 30° relative to the bore axis; and
wherein the seat cut surface and the flow path trajectory are substantially aligned to extend the flow path trajectory of the long turn edge of the inlet port cross section across the seat cut surface.

2. The cylinder head set forth in claim 1 wherein an angular difference between the flow path trajectory and the seat cut surface relative to the bore axis is between 0° and 10°.

3. The cylinder head set forth in claim 2 wherein the angular difference between the flow path trajectory and the seat cut surface is between 0° and 5°.

4. The cylinder head set forth in claim 1 wherein the inlet port includes a throat cut surface at the exit of the inlet port, and adjacent the seat cut surface.

5. The cylinder head set forth in claim 4 wherein the throat cut surface is defined by the structure, and partially defines the inlet port adjacent the exit of the inlet port.

6. The cylinder head set forth in claim 1 wherein the seat cut surface and the throat cut surface are substantially aligned with the flow path trajectory to extend the flow path trajectory across both the throat cut surface and the seat cut surface.

7. The cylinder head set forth in claim 4 wherein the throat cut surface and the seat cut surface are substantially aligned with each other around a circumference of the exit of the inlet port, such that the throat cut surface is substantially an extension of the seat cut surface into the inlet port.

8. The cylinder head set forth in claim 7 wherein the throat cut surface and the seat cut surface each define a respective inward taper angle relative to a reference plane, and wherein the inward taper angle of the throat cut surface and the inward taper angle of the seat cut surface are within 10° of each other.

9. The cylinder head set forth in claim 8 wherein the inward taper angle of the throat cut surface and the inward taper angle of the seat cut surface are within 5° of each other.

10. The cylinder head set forth in claim 1 further comprising a valve seat insert coupled to the structure, wherein the valve seat insert defines the seat cut surface.

11. A cylinder head for an internal combustion engine, the cylinder head comprising:
a structure defining an inlet port having an exit, and including a throat cut surface at the exit of the inlet port;
an inlet valve moveably supported by the structure, and including a seat;
a valve seat insert coupled to the structure, and defining a seat cut surface disposed adjacent the throat cut surface at the exit of the inlet port;
wherein the inlet port extends along a centerline, and wherein a cross section of the inlet port parallel to the centerline defines a long turn edge of the inlet port cross section and an opposing sharp turn edge of the inlet port cross section;
wherein the long turn edge of the inlet port cross section defines a flow path trajectory that is substantially tangent with the long turn edge of the inlet port cross section at the exit of the inlet port, and projects to an intersection with a bore axis that forms an acute, interior angle that is greater than 30° relative to the bore axis;
wherein the seat cut surface and the throat cut surface are substantially aligned with the flow path trajectory to extend the flow path trajectory of the long turn edge of the inlet port cross section across both the throat cut surface and the seat cut surface.

12. The cylinder head set forth in claim 11 wherein an angular difference between the flow path trajectory and the seat cut surface relative to the bore axis is between 0° and 10°.

13. The cylinder head set forth in claim 12 wherein the angular difference between the flow path trajectory and the seat cut surface is between 0° and 5°.

14. The cylinder head set forth in claim 11 wherein the throat cut surface is defined by the structure, and partially defines the inlet port adjacent the exit of the inlet port.

15. The cylinder head set forth in claim 11 wherein the throat cut surface and the seat cut surface are substantially aligned with each other around a circumference of the exit of the inlet port, such that the throat cut surface is substantially an extension of the seat cut surface into the inlet port.

16. The cylinder head set forth in claim 15 wherein the throat cut surface and the seat cut surface each define a respective inward taper angle relative to a reference plane, and wherein the inward taper angle of the throat cut surface and the inward taper angle of the seat cut surface are within 10° of each other.

17. The cylinder head set forth in claim 16 wherein the inward taper angle of the throat cut surface and the inward taper angle of the seat cut surface are within 5° of each other.

18. An internal combustion engine comprising:
a block defining at least one cylinder bore extending along a bore axis;
a cylinder head attached to the block, and including an inlet port having an exit, and operable to introduce a mixture of fuel and air into the cylinder bore;
wherein the cylinder head includes a throat cut surface at the exit of the inlet port;
an inlet valve moveably supported by the cylinder head, and including a seat;
a valve seat insert coupled to the structure and disposed around a periphery of the exit of the inlet port;
wherein the valve seat insert defines a seat cut surface disposed adjacent the throat cut surface at the exit of the inlet port, with the seat cut surface and the seat of the inlet valve shaped to engage each other in sealing engagement for sealing the exit of the inlet port;
wherein the inlet port extends along a centerline, and wherein a cross section of the inlet port along a plane defined by the centerline of the inlet port and the bore axis defines a long turn edge of the inlet port cross section and an opposing sharp turn edge of the inlet port cross section;
wherein the long turn edge of the inlet port cross section defines a flow path trajectory that is substantially tangent with the long turn edge of the inlet port cross section at the exit of the inlet port, and projects to an intersection with the bore axis that forms an acute, interior angle that is greater than 30°; and
wherein the seat cut surface and the throat cut surface are substantially aligned with the flow path trajectory to extend the flow path trajectory of the long turn edge of the inlet port cross section across both the throat cut surface and the seat cut surface.

19. The internal combustion engine set forth in claim 18 wherein an angular difference between the flow path trajectory and the seat cut surface relative to the bore axis is between 0° and 10°.

20. The internal combustion engine set forth in claim 19 wherein the throat cut surface and the seat cut surface are substantially aligned with each other around a circumference of the exit of the inlet port, such that the throat cut surface is substantially an extension of the seat cut surface into the inlet port, and wherein the throat cut surface and the seat cut surface each define a respective inward taper angle relative to a reference plane, with the inward taper angle of the throat cut surface and the inward taper angle of the seat cut surface are within 10° of each other.
